(19) United States
(12) Patent Application Publication
(10) Pub. No.: US 2007/0061886 A1
(43) Pub. Date: Mar. 15, 2007

(54) Digital rights management

(75) Inventor: Yanqun Le, Beijing (CN)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/223,060

(22) Filed: Sep. 9, 2005

(51) Int. Cl. H04N 7/16

(52) U.S. Cl. 726/26

(57) ABSTRACT

A DRM enabled UnConnected Device (UCD) has a Near Field Communications transceiver and specific DRM related data. The UCD transmits its DRM data to an external Connected Device (CD) using the NFC transceiver when brought into touch or very close to the CD. The CD responsively performs registration of the UCD with a DRM Rights Issuer using the DRM data of the UCD and provides registration result (DRM Context data) to the UCD wirelessly, either using the NFC or by another wireless connection. The UCD then joins to a common DRM domain with the CD by communicating with the RI via the CD and using the NFC or the other wireless connection. The whole process can be triggered by bringing the CD and UCD together and performed with little or no other user interaction.

### FIELD OF THE INVENTION

The present invention generally relates to digital rights management. The invention relates, in particular but not exclusively, to registering an unconnected device to a digital rights management domain using near field communication to exchange necessary information between the unconnected device and another device.

### BACKGROUND OF THE INVENTION

Digital rights management (DRM) generally enables controlling the use of information so that the rights to the information are suitably enforced. Open Mobile Alliance™(OMA™) has standardised DRM 1.0 and DRM 2.0 (DRM Architecture Draft Version 2.0-20 Aug. 2004) for this purpose.

DRM content is first packaged to protect it from unauthorised access. The content is next made available by a content provider or more specifically by a Content Issuer (CI) of the content provider. The content provider also has a Rights Issuer (RI), and the RI generates a respective Rights Object (RO).

The RO defines how the DRM content may be used. The RO is an XML document specifying permissions and constraints associated with a piece of DRM content. DRM content cannot be used without an associated RO, and may only be used according to the permissions and constraints specified in the RO. OMA DRM makes a logical separation of DRM content from ROs. DRM content and ROs may be requested separately or together, and they may be delivered separately or at the same time. For example, a user can purchase a given DRM content and receive that DRM content and a respective RO in the same transaction. Later, if the RO expires, that is, the usage right provided by the RO expires, the user can purchase a new RO, without having to download the whole DRM content again.

ROs associated with DRM content have to be enforced at the point of consumption. This is modelled in the OMA DRM specifications by the introduction of a DRM Agent. The DRM Agent embodies a trusted component of a device, responsible for enforcing permissions and constraints for DRM content on the device, controlling access to DRM content on the device, and so on.

Each DRM Agent desiring to use DRM content first has to register to the respective RI if not already done so. The registration results in an RI context, that is, RI-specific security information including agreed protocol parameters and certificate preferences. Moreover, the DRM agents may belong to so-called DRM domains which decided by the RI. DRM agents belonging to DRM domains must also have a DRM Context which contains among others a domain key using which the DRM agent may use content provided for use by that domain. A DRM domain is very useful by providing a flexible restriction such that a person may use paid content in her mobile phone and music player, for instance, without need to purchase the same content for each device she uses. It may also be required to permit content protection only if the content is available in various user selectable technologies. However, if a user buys a new DRM 2.0 enabled MP3 player, for instance, to listen music, she will have to join that new DRM Agent to her DRM Domain by registering the device to the RI and joining it to her DRM Domain. These steps require exchange of information between the new DRM Agent and the RI. To enable this exchange, if the device is a connected device, it can communicate with the RI directly; otherwise, if the device is an unconnected device, the user has to connect the new DRM Agent to an Internet enabled DRM Agent with Universal Serial Bus (USB) or Bluetooth, for instance. To this end, there are some technologies and proposals to trigger the registration and joining of the new DRM Agent, but generally they would involve making multiple selections by menus or dedicated keys and could call for understanding of DRM beyond the knowledge of normal users at present. However, given that the easy legal sharing of protected content is of great commercial interest all possible obstacles and hindrances should be removed.

It is an object of the invention to avoid or at least to mitigate the problems associated with the background art.

### SUMMARY OF THE INVENTION

According to a first aspect of the invention there is provided a method of joining a first Digital Rights Management (DRM) agent to a DRM domain of a second DRM agent in order to allow use of content protected specifically to that DRM domain, wherein the members of the DRM domain are decided by a DRM Rights Issuer (RI), the method including:

allowing the first DRM agent be brought into proximity of the second DRM agent;

receiving by the second DRM agent information specific to the first DRM agent from the first DRM agent, responsively to the first DRM agent coming into proximity of the second DRM agent;

registering by the second DRM agent the first DRM agent to the DRM domain by communicating with the RI; and

joining the first DRM agent to the DRM domain of the second DRM agent at least partly responsive to the first DRM agent coming into proximity of the second DRM agent.

Advantageously, any new DRM agent may be intuitively and easily joined to a DRM domain to which another DRM agent belongs by using communication capability of the other DRM agent. It is particularly useful that the indication of the desire to join the domain and the necessary transfer of information for registering the new DRM agent can both be made with a stroke of hand by simply making the two agents touch or come to proximity.

The receiving of information by the second DRM agent may take place using Near Field Communication. The maximum distance supported in normal conditions for the receiving may be 2 or 3 centimetres or no more than 5 centimetres. The very limited range helps to unambiguously point the desired joining with little risk of erroneous conclusions being made about the desire to join a new device to the DRM domain.

The joining of the first DRM agent to the DRM domain of the second DRM agent may involve wireless communications between the first and second DRM agents. The wireless communications may advantageously be Near Field Communications. The joining may further involve communicating by the second DRM agent with the RI. The second DRM agent may obtain and provide a Domain Context for the first DRM agent.

The communications between the first and the second DRM agent and/or the communications between the second DRM agent and the RI may use the Rights Object Acquisition Protocol (ROAP). The ROAP is a suite of DRM security protocols between a RI and a DRM Agent in a Device and particularly suitable for said communications.

The second DRM agent may subject to a user confirmation the registering of the first DRM agent with the RI and/or the joining of the first DRM agent to the domain. Advantageously, undesired registering and/or joining of foreign DRM agents by accidental or malicious touching can be inhibited by prompting the user first before starting communication to register the first DRM agent. This is also especially useful if the registration and/or joining makes use of cost-bearing transactions such as communicating over a mobile communications network. The user confirmation may be sought by attempting to read from the first DRM agent an authorisation known to the user of the second DRM agent. Hence, in rightful attempt to register the first DRM agent, a code set for the second DRM agent may be entered to the first DRM agent before or when the first DRM agent is brought to proximity with the second DRM agent and the registration by the second DRM agent be authorised without necessarily using or even needing any user interface of the second DRM agent. The code may correspond to information related to the user or the second DRM agent and/or to information input by the user of the second DRM agent, such as the name or telephone number associated with the second device.

The second DRM agent may detect the first DRM agent being brought into proximity and responsively to seek for identification to the desired DRM domain in case that there are more than one DRM domains to which the second DRM agent belongs to. The identification of the desired DRM domain may be based on information received from the first DRM agent. Hence, a user of the first DRM agent may pre-empt the need to separately enquire such information. Alternatively, the first DRM agent may provide the identification of the desired DRM domain automatically without further user interaction.

Advantageously, even if the method would involve prompting a user to select a desired DRM domain of the second DRM agent, the joining would still be at least partly responsive to the first DRM agent coming into proximity of the second DRM agent since this would have initiated the process involving the prompting. Hence, even if further user interaction were needed, the process as a whole would yet appear as a unified single process starting from bringing the two DRM agents together.

The second DRM agent may advantageously send registration related information to the first agent responsive to successfully registering the first DRM agent to the RI. The registration related information may include RI Context information.

According to a second aspect of the invention there is provided a method of joining a first Digital Rights Management (DRM) agent to a DRM domain of a second DRM agent in order to allow use of content protected specifically to that DRM domain, wherein the members of the DRM domain are decided by a DRM Rights Issuer (RI), the method including:

allowing the first DRM agent be brought into proximity of the second DRM agent;

sending by the first DRM agent information specific to the first DRM agent to the second DRM agent, responsively to the first DRM agent coming into proximity of the second DRM agent, in order to allow the second DRM agent to register the first DRM agent to the DRM domain by communicating with the RI; and

joining the first DRM agent to the DRM domain of the second DRM agent at least partly responsive to the first DRM agent coming into proximity of the second DRM agent.

According to a third aspect of the invention there is provided a second Digital Rights Management (DRM) agent associated with a DRM domain for joining a first DRM agent to the DRM domain of the second DRM agent in order to allow use of content protected specifically to that DRM domain, wherein the members of the DRM domain are decided by a DRM Rights Issuer (RI) and wherein the first and second DRM agents can be brought into proximity of each other, the second DRM agent including:

a receiver for receiving information specific to the first DRM agent from the first DRM agent, responsively to the first DRM agent coming into proximity of the second DRM agent; and

a transceiver for registering the first DRM agent to the DRM domain by communicating with the RI and for communicating with the RI for joining the first DRM agent to the DRM domain of the second DRM agent at least partly responsive to the first DRM agent coming into proximity of the second DRM agent.

Advantageously, the second DRM agent may register to the RI and join to a DRM domain unconnected DRM agents that are capable of communicating over short range with, for example, Near Field Communications (NFC).

The second DRM agent may further include a transmitter for sending information returned by the RI to the first DRM agent. The transmitter may be a short range communications transmitter such as an NFC, Infra-Red (IR) or Bluetooth transmitter. Advantageously, using a wireless transmitter and receiver, the second DRM agent need not made to contact with the first DRM agent and thus careful physical alignment of the agents can be avoided.

According to a fourth aspect of the invention there is provided a first Digital Rights Management (DRM) agent for joining to a DRM domain associated with a second DRM agent in order to allow use of content protected specifically to that DRM domain, wherein the members of the DRM domain are decided by a DRM Rights Issuer (RI) and wherein the first and second DRM agents can be brought into proximity of each other, the first DRM agent including:

a transmitter for sending information specific to the first DRM agent to the second DRM agent, responsively to the first DRM agent coming into proximity of the second DRM agent, in order to allow the second DRM agent to register the first DRM agent to the DRM domain by communicating with the RI; and

a receiver for receiving information from the second DRM agent for joining to the DRM domain of the second DRM agent at least partly responsive to the first DRM agent coming into proximity of the second DRM agent.

According to a fifth aspect of the invention there is provided a system including a first Digital Rights Management (DRM) agent and a second DRM agent that is associated with a DRM domain and capable of joining a first DRM agent to the DRM domain of the second DRM agent in order to allow use of content protected specifically to that DRM domain, wherein the members of the DRM domain are decided by a DRM Rights Issuer (RI) and wherein the first and second DRM agents can be brought into proximity of each other, the system including:

a transmitter at the first DRM agent for sending information specific to the first DRM agent to the second DRM agent, responsively to the first DRM agent coming into proximity of the second DRM agent;

a receiver at the second DRM agent for receiving information specific to the first DRM agent from the first DRM agent;

a transceiver for registering the first DRM agent to the DRM domain by communicating with the RI as a result of the first and second DRM agent coming into proximity with each other; and

a transmitter at the second DRM agent for sending information to the first DRM agent for joining the first DRM agent to the DRM domain of the second DRM agent at least partly responsive to the first DRM agent coming into proximity of the second DRM agent.

According to a sixth aspect of the invention there is provided a near field communications signal for indirectly registering a first Digital Rights Management (DRM) agent to a DRM Rights Issuer (RI), comprising information specific to the first DRM agent in order to allow a second DRM agent to register the first DRM agent to the DRM domain by communicating information contained by the signal to the RI.

According to a seventh aspect of the invention there is provided a computer program for controlling a second Digital Rights Management (DRM) agent associated with a DRM domain for joining a first DRM agent to the DRM domain of the second DRM agent in order to allow use of content protected specifically to that DRM domain, wherein the members of the DRM domain are decided by a DRM Rights Issuer (RI) and wherein the first and second DRM agents can be brought into proximity of each other, the computer program including:

computer executable program code for enabling the second DRM agent to receive information specific to the first DRM agent from the first DRM agent, responsively to the first DRM agent coming into proximity of the second DRM agent;

computer executable program code for enabling the second DRM agent to register the first DRM agent to the DRM domain by communicating with the RI; and

computer executable program code for enabling the second DRM agent to communicate with the RI for joining the first DRM agent to the DRM domain of the second DRM agent at least partly responsive to the first DRM agent coming into proximity of the second DRM agent.

According to an eighth aspect of the invention there is provided a computer program for controlling a first Digital Rights Management (DRM) agent for joining to a DRM domain associated with a second DRM agent in order to allow use of content protected specifically to that DRM domain, wherein the members of the DRM domain are decided by a DRM Rights Issuer (RI) and wherein the first and second DRM agents can be brought into proximity of each other, the computer program including:

computer executable program code for enabling the first DRM agent to send information specific to the first DRM agent to the second DRM agent, responsively to the first DRM agent coming into proximity of the second DRM agent, in order to allow the second DRM agent to register the first DRM agent to the DRM domain by communicating with the RI; and

computer executable program code for enabling the first DRM agent to receive information from the second DRM agent for joining to the DRM domain of the second DRM agent at least partly responsive to the first DRM agent coming into proximity of the second DRM agent.

According to a ninth aspect of the invention there is provided a Digital Rights Management (DRM) agent capable of joining to a DRM domain, comprising

proximity transmitter adapted to indicate to corresponding proximity receiver the proximity of the proximity transmitter for indicating the desire to join the DRM domain on the proximity basis, the proximity transmitter further being adapted to transmit information sufficiently describing the DRM agent for the DRM agent becoming registered with a Rights Issuer responsible for joining members to the DRM domain.

Advantageously, the DRM agent can indicate by its proximity the desire to join to a DRM domain and to also transfer the necessary information to do so on a single action of the user of the DRM agent, that is, bringing the DRM agent together or into proximity with another DRM agent equipped with means for registering DRM agent with the RI. Hence, the DRM agent of the third aspect need not be capable of communicating with the RI itself but may use the another DRM agent to do so using that another DRM agent as a proxy.

Various embodiments of the present invention have been illustrated only with reference to one aspect of the invention for sake of briefness, but it should be appreciated that corresponding embodiments may apply to other aspects as well.

### BRIEF DESCRIPTION OF THE DRAWINGS

The invention will now be described, by way of example only, with reference to the accompanying drawings, in which:

FIG. 1 presents a system including according to an embodiment of the invention;

FIG. 2 presents a simplified block diagram of a connected device (CD) of FIG. 1;

FIG. 3 presents a simplified block diagram of an unconnected device (UCD) of FIG. 1

FIG. 4 presents a signalling diagram indicative of main signals and events in the process of joining the UCD to a common domain with the CD in a system of FIG. 1;

FIG. 5 shows a flow chart illustrating the operation of the CD of FIG. 1 according to an embodiment of the invention; and

FIG. 6 shows a flow chart illustrating the operation of the UCD of FIG. 1 according to an embodiment of the invention.

### DETAILED DESCRIPTION

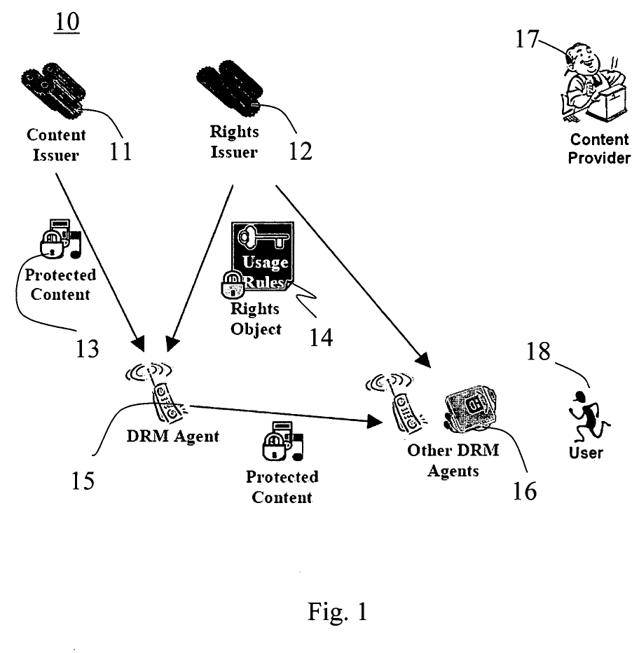

FIG. 1 presents a system 10 including according to an embodiment of the invention. The system includes a Content Issuer (CI) 11, a Rights Issuer (RI) 12, Protected Content (PC) 13 or content in short, Rights Objects (RO) 14, a Connected Device (CD) 15 and an unconnected device 16. The CI 11 and RI 12 are typically run by a Content Provider (CP) 17 whilst the CD 15 and the UCD 16 are operated by one or more users 18. The CD 15 is generally capable of communicating with the CI and/or the RI unlike the UCD 16 that is not. The CD 15 may be a mobile phone or an internet terminal of fixed or wireless nature such as a WLAN enabled PDA or gaming device. The UCD 16 may be an audio or video terminal or an entertainment device, for instance, such as a music player, a portable music player, an electronic book, a video player or a gaming device. Naturally the UCD 16 may be capable of as two or more of the above-mentioned devices.

The system 10 may be compatible with the Open Mobile Alliance (OMA) DRM draft specification 2.0 (DRM Specification V2.0 Candidate Version 2.0-10 Dec. 2004). However, it may also be compatible only or additionally with other DRM specifications or proprietary systems. OMA DRM refers to the operative part of a user device as a DRM agent. In the following, any of terms DRM device, CD 15 and UCD 16 may be used to refer to a DRM agent in sake of simplicity of understanding the description.

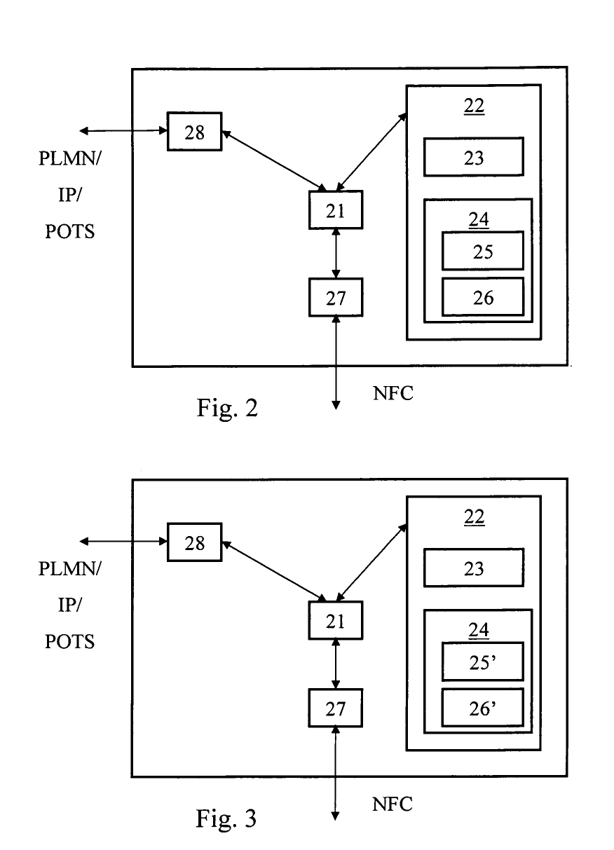

The system 10 is further explained in more detail with reference to FIGS. 2 and 3 illustrating the structure of the CD 15 and the UCD 16, respective flow charts 5 and 6 and a signalling diagram 4. The system 10 is capable of providing content 13 and respective use ROs 14 to CD 15 (any of plurality of such devices) and the RO 14 is capable of registering the UCD 16 to the RI in order to extend the usage rights of content 13 to the UCD 16. The system 10 is intended to enable easily setting the UCD 16 into a capability of using content 13 provided to the CD 15. The present invention aims to particularly facilitate transferring information between the CD 15 and the UCD 16 to join the UCD into a domain of the CD 15 simply on touching the CD 15 with the UCD 16 or vice versa.

FIG. 2 presents a simplified block diagram of the CD 15 of FIG. 1. The CD 15 contains a processor 21 for processing information and generally controlling the operation of the CD 15, a memory 22 including a work memory 23 for volatile but fast access memory and a persistent memory 24 for holding long-term data including DRM data 25 and computer program code 26 that is designed to control the operation of the processor 21, a Near Field Communications (NFC) block 27 for very short range communications with another NFC enabled devices and a transceiver 28 for communicating with the RI and possibly with other entities. Both the NFC block 27 and the transceiver 28 can consist of or contain circuitry embedded into other components of the CD 15, including those not mentioned here, mounted onto a circuit board or other assembly module within or installable to the CD 15, or externally connectable modules. The transceiver 28 can be a wireless transceiver compatible with cellular or satellite communications, a fixed transceiver such as an Internet or intranet communications transceiver such as a Network Interface Card (NIC) or a modem such as any DSL or analogue modem or ISDN terminal. The computer executable code is advantageously in a compiled form such that it is directly executable by the processor 21, though alternatively it may be code that is interpreted with a suitable software based interpreter including Java™, Symbian or Brew™. The NFC block 27 typically uses radio magnetic signalling to exchange information with very proximate devices, typically over range 1 to 5 centimetres. Alternatively, the NFC block 27 can have a range of substantially less than 1 cm. The NFC block 27 may even require a contact or near contact (e.g. capacitive or inductive connection) to communicate.

FIG. 3 presents a simplified block diagram of the UCD 16 of FIG. 1 basically lacking the transceiver 28 in comparison to the CD 15 and FIG. 2. The operating systems and the types of computer code 26 and their exact implementation may vary between the CD 15 and the UCD 16 as well as the DRM data 25 and hence the computer program code and the DRM data are denoted in FIG. 3 as 26′ and 25′. All the parts with common reference signs may be similar or may differ though having basically a similar function with respect of this description, these are denoted identically.

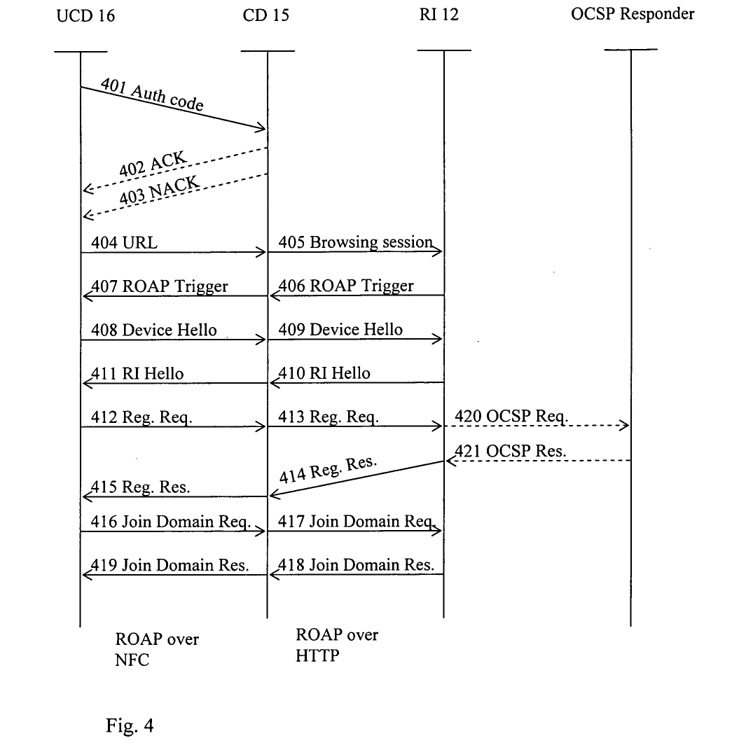

FIG. 4 presents a signalling diagram indicative of main signals and events in the process of joining the UCD 16 to a common domain with the CD 15 in the system 10 of FIG. 1. To start with, it should be appreciated that the process and signalling is open for numerous modifications, but the best modes known to the inventor are next explained.

The user first brings together the UCD 16 and the CD 15. Responsively, the UCD 16 authenticates itself to the CD 15 with a signal 401 carrying a code known to the CD 15 and responsively receives an ACK signal 402, a NACK signal 403 or no signal at all, especially if NACKs are used for negative indication and no NACK at all on success. After an ACK 402 or no NACK 403 within a preset interval, the UCD 16 sends in signal 404 a URL or other indication of the desired content and its own DRM indication information to the CD 15 using the NFC block 27. The CD 15 starts a respective browsing session 405 to the RI 12 and thus causes the RI 12 send a response signal 406 from the RI 12 to the CD 15 for passing to the UCD 16 in signal 407. The UCD 16 replies to the RI with Device Hello signals 408 and 409 on the legs to CD 15 and between CD 15 and the RI 12 and receives responsive RI Hello signals 410 and 411 over the two legs in communication between the UCD 16 and the RI 12. Next the UCD 16 and the RI 12 communicate with the following signals on alternating directions: Registration request 412, 413; and Registration response 414, 415. These messages register the UCD 16 to the RI 12 and enable subsequently joining the UCD 16 to domain of the RI 12 common with the CD 15. The UCD 16 sends a JoinDomainRequest signal 416, 417 to the RI 12 and responsively receives a JoinDomainResponse signalling 418, 419 carrying the information necessary to use the content with the RO 14.

IF the NFC block 27 is relatively slow and the touching should conversely be excessively long lasting, say above 3, 5 or 10 seconds, faster Low Power Radio Frequency (LPRF) ports such as a Bluetooth™ ports can be provided to the CD 15 and to the UCD 16 and configured to be triggered to transmit some of the signalling over the LPRF to either or both speed up the communications and reduce the time required for the CD 15 and UCD 16 being in touch. The initialisation of such a session may involve sending further signals over the LPRF as is known in the art and unnecessary to describe here.

Optionally, the RI 12 may subject the registration request processing to a successful request to an OCSP Responder generally known from OMA DRM. Steps 420 and 421 can be used for an RI 12 to optionally perform a nonce-based OCSP request for its own certificate (using a nonce supplied by the Device) during the registration protocol, and then provide the Device with the returned OCSP response. The RI 12 will perform this nonce-based OCSP request if it determines that the Device's DRM Time is inaccurate. A Device will then be able to adjust its DRM Time based on the time in the OCSP response. If the Device is an Unconnected Device that does not support DRM Time, the RI must perform a nonce-based OCSP request for its own certificate (using a nonce supplied by the Device) during the registration protocol.

As shown in FIG. 4, the communications between the CD 15 and the UCD 16 may use Rights Object Acquisition Protocol (ROAP) over NFC and the communications between the CD 15 and the RI may use the ROAP over HTTP. Through ROAP, the necessary authentication, authorization and other security parameters exchange can advantageously be done between a DRM Agent and a RI. ROAP includes a 4-pass Registration protocol that is a complete security information exchange and handshake protocol for use between the RI and the Device. Successful completion of the Registration protocol results in the establishment of an RI Context in the Device containing RI-specific security related information such as agreed protocol parameters, protocol version, and certificate preferences. An RI Context is necessary for execution of the other protocols in the ROAP suite. The join/leave domain protocol is used for a Device to join or leave a Domain. Successful completion of the Join Domain protocol results in the establishment of a Domain Context in the Device containing Domain-specific security related information including a Domain Key. A Domain Context is necessary for the Device to be able to install and utilize Domain ROs. The RO acquisition protocol is for the Device to acquire ROs.

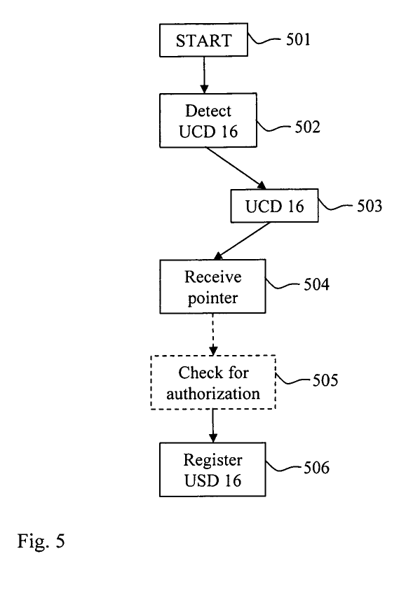

FIG. 5 shows a flow chart illustrating the operation of the CD 15 of FIG. 1 according to an embodiment of the invention. The operation starts from block 501, wherein the CD 15 is idling with regard to DRM domain management operations. The CD 15 first detects 502 the UCD 16 brought into proximity of the CD 15. Then, the CD 15 handshakes 503 with the UCD 16. The CD 15 next receives 504 a pointer (such as URL) to the DRM information of the UCD 16 from the UCD 16. Before proceeding with registering the UCD 16, the CD 15 optionally first checks 505 for authorisation to do so by either prompting itself for acceptance with two soft keys, for instance (accept registration/cancel), or by obtaining respective authorisation using a code known to its user from the UCD 16. On passing positively the checking of step 505, or in any case if the optional step 505 is omitted, the CD 15 next registers 506 the UCD 16 to the DRM domain by communicating with the RI and joins the UCD 16 to the DRM domain of the CD 15.

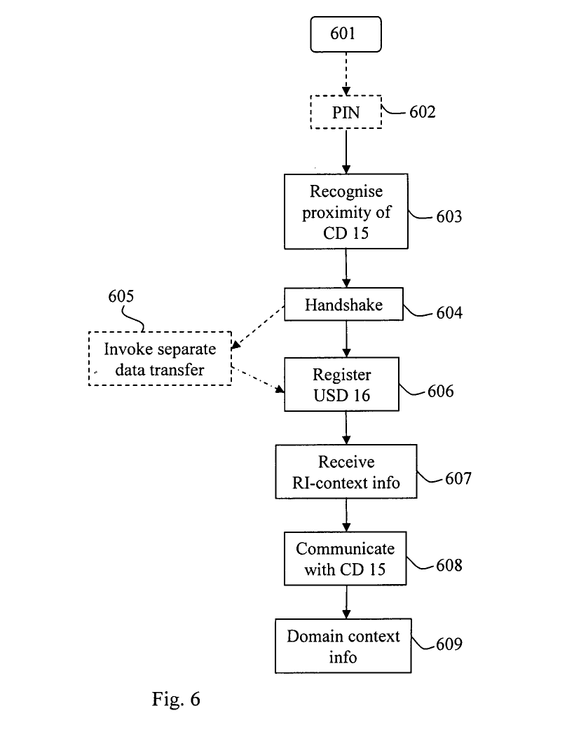

FIG. 6 shows a flow chart illustrating the operation of the UCD 16 of FIG. 1 according to an embodiment of the invention. The operation starts from step 601, wherein the UCD 16 is idling with regard to DRM domain management operations. The user of the UCD 16 next optionally feeds 602 into the UCD 16 a PIN for using the CD 15 in registering the UCD 16 to a DRM domain. This feeding of PIN may take place using a settings menu or it may occur on putting the UCD 16 together with the CD 15 on prompting by the UCD 16. The UCD 16 is next placed close (to “touch”) with the CD 15 by moving at least either of these and the UCD 16 recognises 603 the proximity of the CD 15 and handshakes 604 with the CD 15 using NFC. The UCD 16 provisions its DRM indication information to the CD 15 over the NFC. Alternatively to providing merely a pointer to the DRM information, the UCD 16 may send all or sufficient amount of its DRM information for the registration or invoke 605 a separate data transmission of the DRM information to the CD 15 over a wireless or wired communications link between the UCD 16 and the CD 15. The link is preferably a Low-Power Radio Frequency (LPRF) link such as Bluetooth link for convenience of use. The UCD 16 next waits 606 for the CD 15 to register the UCD 16 to the RI 12 using DRM information of the CD 15 and receives 607 RI context information preferably over the wireless from the CD 15. The UCD 16 then communicates 608 with the CD 15 for the CD 15 to join the UCD 16 to the DRM domain of the CD 15 and responsively receives 609 domain context information that enables the UCD 16 to subsequently use content protected specifically to the DRM domain in question.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. A number of features were described as part of examples in the foregoing and wherever technically possible, the features should be regarded as optional and combinable with any different other examples of the description. For instance, the invention is useful also in various electronic devices, particularly in portable electronic books, PDA devices, gaming devices, musc players, DRM enabled set-top boxes capable of providing limited access to (rented) content and GPS positioning devices. Hence, the scope of the invention is only restricted by the attached patent claims.

1. A method of joining a first Digital Rights Management (DRM) agent to a DRM domain of a second DRM agent in order to allow use of content protected specifically to that DRM domain, wherein the members of the DRM domain are decided by a DRM Rights Issuer (RI), the method including:
allowing the first DRM agent be brought into proximity of the second DRM agent;
receiving by the second DRM agent information specific to the first DRM agent from the first DRM agent, responsively to the first DRM agent coming into proximity of the second DRM agent;
registering by the second DRM agent the first DRM agent to the DRM domain by communicating with the RI; and
joining the first DRM agent to the DRM domain of the second DRM agent at least partly responsive to the first DRM agent coming into proximity of the second DRM agent.

2. A method according to claim 1, wherein the receiving of information by the second DRM agent and/or the joining of the first DRM agent to the DRM domain of the second DRM agent involve wireless communications between the first and second DRM agents.

3. A method according to claim 2, wherein the wireless communications is Near Field Communications.

4. A method according to claim 1, wherein the joining further involves communicating by the second DRM agent with the RI.

5. A method according to claim 1, wherein the second DRM agent obtains and provides a Domain Context for the first DRM agent.

6. A method according to claim 1, wherein the communications between the first and the second DRM agent and/or the communications between the second DRM agent and the RI employ Rights Object Acquisition Protocol (ROAP).

7. A method according to claim 1, wherein the second DRM agent subjects to a user confirmation the registering of the first DRM agent with the RI and/or the joining of the first DRM agent to the domain.

8. A method according to claim 1, wherein the second DRM agent detects the first DRM agent being brought into proximity and responsively seeks for identification to the desired DRM domain in case that there are more than one DRM domains to which the second DRM agent belongs to.

9. A method of joining a first Digital Rights Management (DRM) agent to a DRM domain of a second DRM agent in order to allow use of content protected specifically to that DRM domain, wherein the members of the DRM domain are decided by a DRM Rights Issuer (RI), the method including:
allowing the first DRM agent be brought into proximity of the second DRM agent;
sending by the first DRM agent information specific to the first DRM agent to the second DRM agent, responsively to the first DRM agent coming into proximity of the second DRM agent, in order to allow the second DRM agent to register the first DRM agent to the DRM domain by communicating with the RI; and
joining the first DRM agent to the DRM domain of the second DRM agent at least partly responsive to the first DRM agent coming into proximity of the second DRM agent.

10. A second Digital Rights Management (DRM) agent associated with a DRM domain for joining a first DRM agent to the DRM domain of the second DRM agent in order to allow use of content protected specifically to that DRM domain, wherein the members of the DRM domain are decided by a DRM Rights Issuer (RI) and wherein the first and second DRM agents can be brought into proximity of each other, the second DRM agent including:
a receiver for receiving information specific to the first DRM agent from the first DRM agent, responsively to the first DRM agent coming into proximity of the second DRM agent; and
a transceiver for registering the first DRM agent to the DRM domain by communicating with the RI and for communicating with the RI for joining the first DRM agent to the DRM domain of the second DRM agent at least partly responsive to the first DRM agent coming into proximity of the second DRM agent.

11. A second Digital Rights Management agent according to claim 10, wherein the receiving of information by the second DRM agent and/or the joining of the first DRM agent to the DRM domain of the second DRM agent involve wireless communications between the first and second DRM agents.

12. A second Digital Rights Management agent according to claim 11, wherein the wireless communications is Near Field Communications.

13. A second Digital Rights Management agent according to claim 10, wherein the communications between the first and the second DRM agent and/or the communications between the second DRM agent and the RI employ Rights Object Acquisition Protocol (ROAP).

14. A second Digital Rights Management agent according to claim 10, further comprising means for subjecting to a user confirmation the registering of the first DRM agent with the RI and/or the joining of the first DRM agent to the domain.

15. A second Digital Rights Management agent according to claim 10, further comprising means for detecting the first DRM agent being brought into proximity and responsively for seeking for identification to the desired DRM domain in case that there are more than one DRM domains to which the second DRM agent belongs to.

16. The second DRM agent according to claim 10, further including a transmitter for sending information returned by the RI to the first DRM agent, wherein the transmitter is selected from a group consisting of: a short range communications transmitter, a Near Field Communications transmitter, an Infra-Red transmitter, a Bluetooth transmitter and an ultrasound transmitter.

17. A first Digital Rights Management (DRM) agent for joining to a DRM domain associated with a second DRM agent in order to allow use of content protected specifically to that DRM domain, wherein the members of the DRM domain are decided by a DRM Rights Issuer (RI) and wherein the first and second DRM agents can be brought into proximity of each other, the first DRM agent including:
a transmitter for sending information specific to the first DRM agent to the second DRM agent, responsively to the first DRM agent coming into proximity of the second DRM agent, in order to allow the second DRM agent to register the first DRM agent to the DRM domain by communicating with the RI; and
a receiver for receiving information from the second DRM agent for joining to the DRM domain of the second DRM agent at least partly responsive to the first DRM agent coming into proximity of the second DRM agent.

18. A first Digital Rights Management agent according to claim 17, wherein the receiving of information by the second DRM agent and/or the joining of the first DRM agent to the DRM domain of the second DRM agent involve wireless communications between the first and second DRM agents.

19. A second Digital Rights Management agent according to claim 11, wherein the wireless communications is Near Field Communications.

20. A second Digital Rights Management agent according to claim 11, wherein the communications between the first and the second DRM agent and/or the communications between the second DRM agent and the RI employ Rights Object Acquisition Protocol (ROAP).

21. A system including a first Digital Rights Management (DRM) agent and a second DRM agent that is associated with a DRM domain and capable of joining a first DRM agent to the DRM domain of the second DRM agent in order to allow use of content protected specifically to that DRM domain, wherein the members of the DRM domain are decided by a DRM Rights Issuer (RI) and wherein the first and second DRM agents can be brought into proximity of each other, the system including:
a transmitter at the first DRM agent for sending information specific to the first DRM agent to the second DRM agent, responsively to the first DRM agent coming into proximity of the second DRM agent;
a receiver at the second DRM agent for receiving information specific to the first DRM agent from the first DRM agent;
a transceiver for registering the first DRM agent to the DRM domain by communicating with the RI as a result of the first and second DRM agent coming into proximity with each other; and
a transmitter at the second DRM agent for sending information to the first DRM agent for joining the first DRM agent to the DRM domain of the second DRM agent at least partly responsive to the first DRM agent coming into proximity of the second DRM agent.

22. A near field communications signal for indirectly registering a first Digital Rights Management (DRM) agent to a DRM Rights Issuer (RI), comprising information specific to the first DRM agent in order to allow a second DRM agent to register the first DRM agent to the DRM domain by communicating information contained by the signal to the RI.

23. A computer program for controlling a second Digital Rights Management (DRM) agent associated with a DRM domain for joining a first DRM agent to the DRM domain of the second DRM agent in order to allow use of content protected specifically to that DRM domain, wherein the members of the DRM domain are decided by a DRM Rights Issuer (RI) and wherein the first and second DRM agents can be brought into proximity of each other, the computer program including:
computer executable program code for enabling the second DRM agent to receive information specific to the first DRM agent from the first DRM agent, responsively to the first DRM agent coming into proximity of the second DRM agent;
computer executable program code for enabling the second DRM agent to register the first DRM agent to the DRM domain by communicating with the RI; and
computer executable program code for enabling the second DRM agent to communicate with the RI for joining the first DRM agent to the DRM domain of the second DRM agent at least partly responsive to the first DRM agent coming into proximity of the second DRM agent.

24. A computer program for controlling a first Digital Rights Management (DRM) agent for joining to a DRM domain associated with a second DRM agent in order to allow use of content protected specifically to that DRM domain, wherein the members of the DRM domain are decided by a DRM Rights Issuer (RI) and wherein the first and second DRM agents can be brought into proximity of each other, the computer program including:
computer executable program code for enabling the first DRM agent to send information specific to the first DRM agent to the second DRM agent, responsively to the first DRM agent coming into proximity of the second DRM agent, in order to allow the second DRM agent to register the first DRM agent to the DRM domain by communicating with the RI; and
computer executable program code for enabling the first DRM agent to receive information from the second DRM agent for joining to the DRM domain of the second DRM agent at least partly responsive to the first DRM agent coming into proximity of the second DRM agent.

25. A Digital Rights Management (DRM) agent capable of joining to a DRM domain, comprising
proximity transmitter adapted to indicate to corresponding proximity receiver the proximity of the proximity transmitter for indicating the desire to join the DRM domain on the proximity basis, the proximity transmitter further being adapted to transmit information sufficiently describing the DRM agent for the DRM agent becoming registered with a Rights Issuer responsible for joining members to the DRM domain.
